(19) United States
(12) Patent Application Publication
(10) Pub. No.: US 2021/0362190 A1
(43) Pub. Date: Nov. 25, 2021

(54) Horticulture Classifier Apparatus

(71) Applicant: Zachery Minissale, Nevada City, CA (US)

(72) Inventor: Zachery Minissale, Nevada City, CA (US)

(21) Appl. No.: 17/326,174

(22) Filed: May 20, 2021

Related U.S. Application Data
(60) Provisional application No. 63/027,485, filed on May 20, 2020.

(51) Int. Cl. B07B 1/02; A01F 25/14; B07B 1/46

(52) U.S. Cl. CPC B07B 1/02; B07B 1/4609; A01F 25/14

(57) ABSTRACT

The horticulture classifier apparatus is intended to provide users with a sifting and sorting device that can separate multiple sizes of plant material. To accomplish this, the device includes specific surface contours and multi-purpose handling structures to be described in relation to a sieve grid. Further, the apparatus includes critical functional elements relating to the separation of whole marijuana buds, specifically, that are presented as novelties. To that end, a sifting screen is included, which may be detachably mounted onto the main classifying grid. In addition, the apparatus includes means for mounting the device on multiple kinds of totes and bins, to sequentially separate the various tiers of consumable cannabis. This arrangement may also include attachment to an external collection bin or bag, depending on the individual application of the apparatus by a user.

The current application claims a priority to the U.S. Provisional Patent application Ser. No. 63/027,485 filed on May 20, 2020.

### FIELD OF THE INVENTION

The present invention relates generally to the field of horticulture tools and implements, specifically to the separation of various plant matter via an improved iteration of a conventional classifier sieve. More specifically, the present invention is directed towards the separation of various grades of raw marijuana plant via mechanical agitation of the tool described herein.

### BACKGROUND OF THE INVENTION

Simple horticultural tools that can efficiently separate plant matter into various sizes are always in demand. Further, in recent years, the marijuana industry within the United States has grown explosively as various jurisdictions decriminalize or outright legalize the purchase and possession of the formerly banned substance. Individual and industrial growers have expanded domestic production to serve new customers, including the development of new techniques and tools supporting the specific processes by which raw plant may be rendered into consumable forms. Existing crop handling tools may be adequate for these purposes, but the specific horticultural properties and harvest processes of marijuana may leave something to be desired. More simply, the tools used for other forms of farming and harvest processing are less than ideal due to a lack of focus in their design. Accordingly, there is an emerging need for suitable tools for processing large quantities of marijuana into separated volumes of progressively graded products such as prime A-grade, B-grade (‘B Buds’), C-grade (‘shake’), and further grades as may be recognized within the industry. These grades are notable for their differing uses and methods of consumption but are most notably distinguished by a difference in diameter for individual motes of each grade. Thus, it is possible to separate whole product into said grades using a novel application and embodiment of sieve and classifier technology.

It is an objective of the present invention to provide users with a sifting and sorting device that can separate multiple sizes of plant material. The present invention aims to provide a substantial improvement over conventional plant matter separators by the planned application of specific surface contours and multi-purpose handling structures to be described in relation to a sieve grid. Though the dimensions and facile geometry of the exemplary embodiment of the present invention may be modified in various alternate embodiments, the critical functional elements relating to the separation of whole marijuana buds, specifically, are presented as novelties. Further, the present invention comprises detachable sifting screens, that enable to classify plant products into various sizes according to the users' preference. In addition, the present invention recites a means of mounting multiple iterations of the present invention vertically to sequentially separate the various tiers of consumable cannabis. This arrangement may also include attachment to an external collection bin or bag, depending on the individual application of the present invention by a user. Thus, the present invention is an improved horticultural classifier tool.

### BRIEF DESCRIPTION OF THE DRAWINGS

FIG. 1 is a top-front-left perspective view of a receptacle, according to a preferred embodiment of the present invention.

FIG. 2 is a bottom-rear-right perspective view of the receptacle.

FIG. 3 is a top plan view of the receptacle.

FIG. 4 is a front elevational view of the receptacle.

FIG. 5 is a left-side elevational view of the receptacle.

FIG. 6 is a top plan view of a separator screen according to a preferred embodiment of the present invention.

FIG. 7 is a right-side elevational view of the separator screen.

FIG. 8 is a front elevational view of the separator screen.

FIG. 9 is a top plan view of the receptacle with the separator screen mounted over the base of the receptacle.

### DETAIL DESCRIPTIONS OF THE INVENTION

All illustrations of the drawings are for the purpose of describing selected versions of the present invention and are not intended to limit the scope of the present invention.

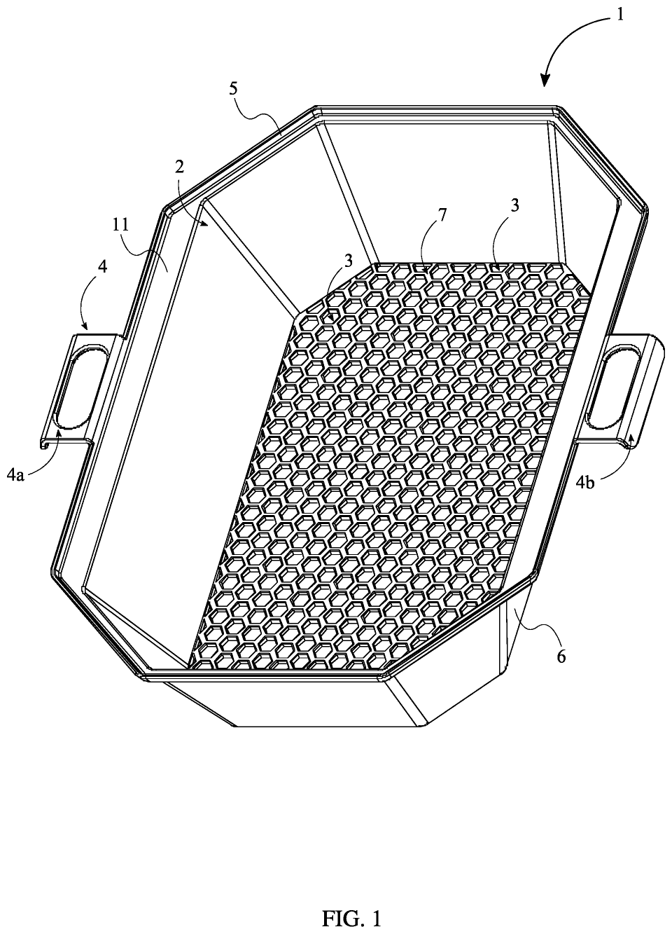

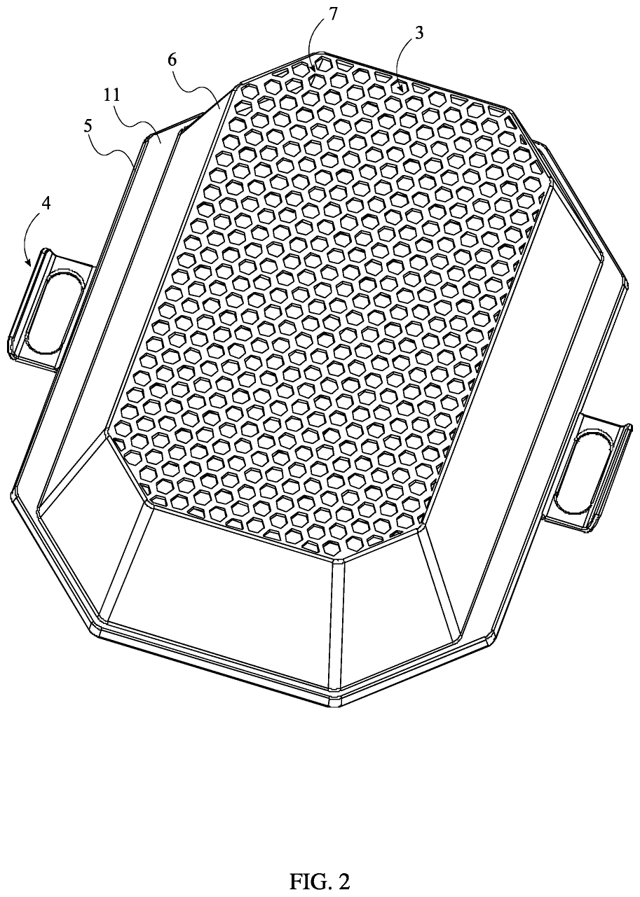

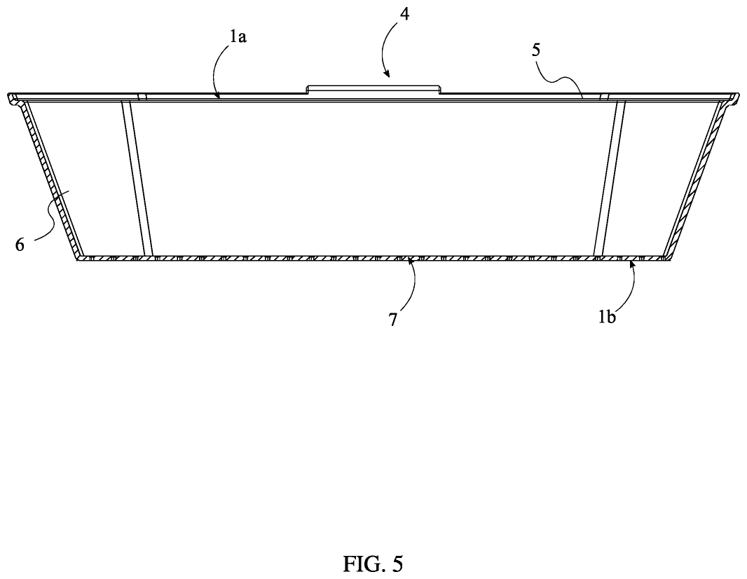

In reference to FIG. 1 through FIG. 9, the present invention is a horticulture classifier apparatus. The horticulture classifier apparatus is intended to provide users with a sifting and sorting device that can separate multiple sizes of plant material. To accomplish this, the present invention comprises specific surface contours and multi-purpose handling structures to be described in relation to a sieve grid. Further, the apparatus includes critical functional elements relating to the separation of whole marijuana buds, specifically, that are presented as novelties. To that end, a sifting screen is included, which may be detachably mounted onto the main classifying grid. In addition, the apparatus comprises means for mounting the device on multiple kinds of totes and bins, to sequentially separate the various tiers of consumable cannabis or other plant material. This arrangement may also include attachment to an external collection bin or bag, depending on the individual application of the apparatus by a user.

The following description is in reference to FIG. 1 through FIG. 9. According to a preferred embodiment of the present invention, the classifier apparatus comprises a receptacle 1, an inner cavity 2, a plurality of first perforations 3, and at least one handle 4. Preferably, the receptacle 1 defines a raised area formed about the inner cavity 2 wherein whole marijuana buds or other plant materials may be loaded for processing. The receptacle 1 additionally defines a support structure for repeated iterations of the plant material, through the plurality of first perforations. To that end, the receptacle 1 comprises a rim 5, at least one lateral sidewall 6, and a base 7. The at least one lateral sidewall 6 defines an impermeable barrier connecting between the base 7 and the rim 5, wherein the base 7 is vertically offset from the rim 5. In other words, a first end 1a of the receptacle 1 is positioned opposite to a second end 1b of the receptacle 1 across the at least one lateral sidewall 6, wherein the rim 5 is mounted adjacent the first end 1a and the base 7 is mounted adjacent the second end 1b. As seen in FIG. 1, the inner cavity 2 traverses into the receptacle 1 from the first end 1a towards the second end 1b, such that the inner cavity 2 along with the at least one lateral sidewall 6 defines the capacity or volume of the receptacle 1.

In the preferred embodiment, the present invention is designed to be easily pourable so that the user may pour the plant material back into a tote or bag that it was in before sifting. To that end, the at least one lateral sidewall 6 tapers from the first end 1a towards the second end 1b. This is so that, the tapered sidewall may assist in easy transfer or pouring of the separated plant material left within the receptacle 1 into a separate container. Furthermore, as seen in FIG. 1, the at least one lateral sidewall 6 will define a maximum profile coplanar to the rim 5 and a minimum profile coplanar to the base 7, thereby routing any buds deposited into the classifier apparatus towards the base 7 while preventing any spillage over the rim 5. As seen in FIG. 1 through FIG. 9, the receptacle 1 is octagonal in shape. Additionally, it is preferred that the receptacle 1 is made of a sturdy, yet light weight material such as hard plastic, so that it is easier for the user to perform the sifting and pouring. However, receptacle 1 may comprise any other size, shape, material, components, and arrangement of components that are known to one of ordinary skill in the art, as long as the intents of the present invention are not altered.

In an alternate embodiment, the constituent angles of the taper may be increased in successive iterations such that an arbitrary lateral sidewall may fit within a lateral sidewall 6 to enable a stacked configuration.

To accomplish sifting and classifying of the plant material deposited within the receptacle 1, the plurality of first perforations 3 traverse into the base 7. Accordingly, the base 7 defines a perforated panel forming the lower face of the present invention. In use, the user will manually agitate the receptacle 1 to shift the load of buds across the base 7, thereby dislodging any smaller elements of plant matter and permitting said matter to traverse the base 7 through said plurality of first perforations 3 while retaining any larger matter within the inner cavity. In other words, the user pours plant matter into the receptacle 1 and shake it, such that the user may have two different size plant material separated: the product in the bin or tote below the base 7, and the product remaining in the inner cavity 2. According to the preferred embodiment of the present invention, the plurality of first perforations 3 are coterminous hexagonal portals, each of a given profile and diameter to be determined at a manufacturing stage to be ideal for separating a particular element of an unprocessed bud of marijuana. In other words, as seen in FIG. 1 through FIG. 3, each of the plurality of first perforations 3 is hexagonal in shape It may be understood by a reasonably skilled individual that the each of the plurality of first perforations 3 may define a variety of alternate geometric profiles and dimensions across various embodiments, given the varying dimensions of plant materials. Accordingly, the manufacturing specifications of this feature are variable without departing from the spirit and scope of the present invention. Further, the perimeter of each coterminous portal is ideally rounded or filleted to the center of said portal on the upper face of the separator plate, proximal to the lateral sidewall 6. In other words, each of the plurality of first perforations 3 comprises filleted edges. This is so that, the filleted edge will enable the separation of relatively delicate plant matter without damaging the underlying buds. In contrast, a shear edge may tear or abrade the buds and unduly damage the plant material, thereby causing wastage of otherwise acceptable product.

According to the preferred embodiment, the at least one handle 4 is perimetrically mounted onto the rim 5. Preferably, the at least one handle 4 defines a means of both manually grasping the present invention as well as suspending the present invention on the lip of a separate container or mounting means. More specifically, the at least one handle 4 ideally constitutes a first handle 4a and a second handle 4b, wherein the first handle 4a and the second handle 4b are positioned opposite one another about the receptacle 1. This is so that the base 7 may be suspended across the opening of a tote bin or other similar external container. Further, the opposed handles may also be employed to suspend a collection bag underneath the base to gather any smaller matter as said matter passed through the plurality of first perforations.

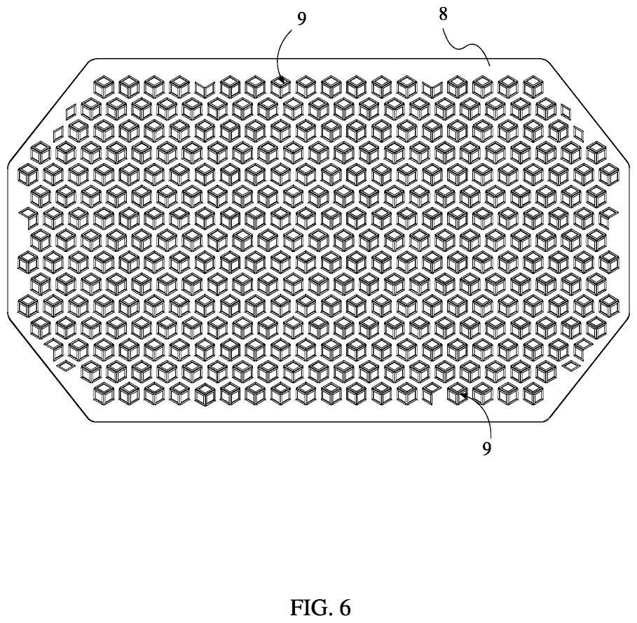

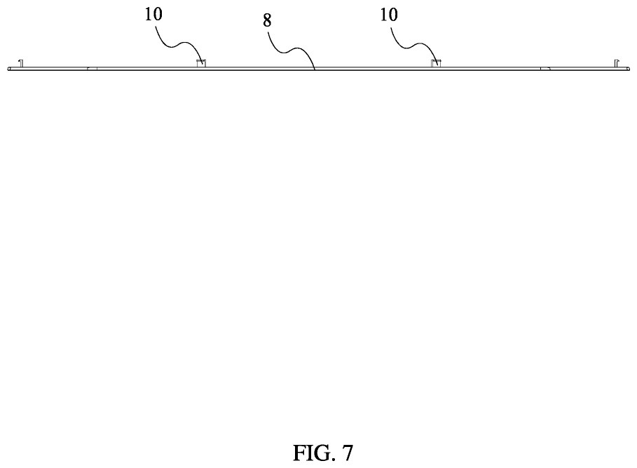

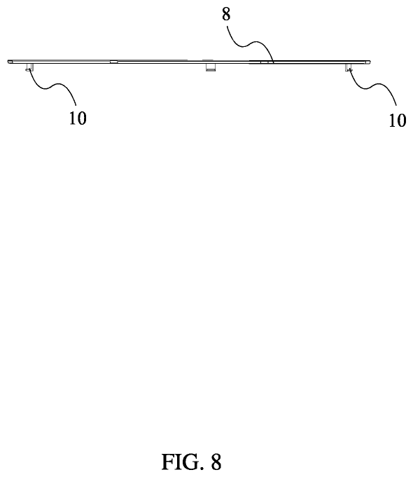

According to the preferred embodiment, the present invention allows users to sift and classify the plant material into categories of multiple sizes. To accomplish this and in reference to FIG. 6 through FIG. 9, the present invention comprises a sifter screen 8 and a plurality of second perforations 9, wherein the plurality of second perforations 9 traverses into sifter screen 8. Preferably, the sifter screen 8 is detachably mounted over the base 7, such that an even finer sieving/sifting may be achieved for plant products within the same receptacle. To that end, each of the plurality of second perforations 9 is smaller than each of the plurality of first perforations 3. As seen in FIG. 6, each of the plurality of second perforations 9 is diamond in shape. More specifically, the plurality of second perforations 9 is a single hexagonal slot, that has been divided into 3 coterminous segments. Further, as seen in FIG. 7 and FIG. 8, the sifting screen 8 is a thin panel made of any sturdy material, preferably of the same material as of the receptacle 1. However, the plurality of second perforations 9 and the sifter screen 8 may comprise any other material, size, shape, components or arrangement of components that are known to one of ordinary skill in the art, as long as the objectives of the present invention are not altered.

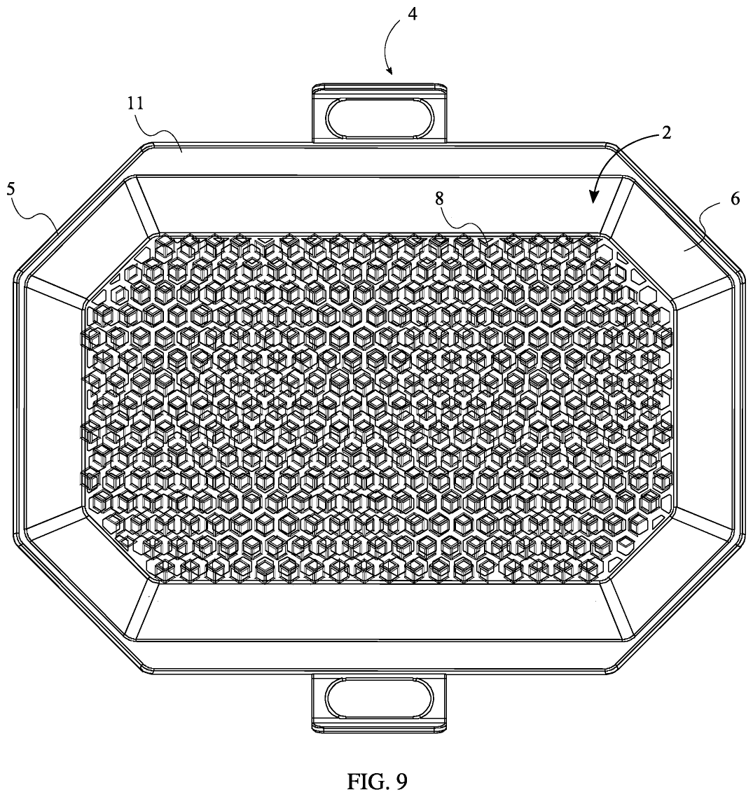

In order to efficiently mount the sifting screen 8 over the base 7, the present invention comprises a plurality of fasteners 10. Preferably, the plurality of fasteners 10 is engaged between the sifter screen 8 and the base 7 in such a way that the fasteners 10 don't alter the sifting/classification process, as well as enable easy attaching and detaching of the sifting screen 8 over and from the base 7 respectively. As seen in FIG. 7 and FIG. 8, the plurality of fasteners 10 are snap on fasteners connected terminally around the sifting screen 8. However, the plurality of fasteners 10 may comprise any other size, shape, fastening techniques etc. that are known to one of ordinary skill in the art, as long as the objectives of the present invention are fulfilled. Examples of such fasteners include, but are not limited to hook and loop fasteners, clips, magnetic fasteners etc. As seen in FIG. 9, in order for the sifter screen 8 to fit perfectly over the base 7, a first transverse cross-section of the base 7 is identical to a second transverse cross-section of the sifting screen 8. Furthermore, each of the plurality of second perforations 9 comprises rounded edges, so as to prevent abrasion of the buds and unduly damage the plant material.

Continuing with the preferred embodiment, the present invention comprises an annular ledge 11. As seen in FIG. 1 through FIG. 3, the annular ledge 11 defines a generally planar surface extending outward from the at least one sidewall 6, parallel to the base 7. In other words, the annular ledge 11 is perimetrically mounted onto the first end 1a, wherein the annular ledge 11 extends laterally from the first end 1a, parallel to the base 7. Preferably, the annular ledge 11 serves as a mounting point for the at least one handle 4 of the present invention in one configuration. The annular ledge 11 may further serve as a buffer zone to prevent the ejection of any buds from the classifier apparatus during use. Further, as seen in FIG. 1, the rim 5 is perimetrically and terminally mounted onto the annular ledge 11, wherein the rim 5 extends normally from the annular edge 11, in a direction opposite to the base 7. In other words, the rim 5 defines a retaining edge extending perpendicularly from the annular ledge 11 between the annular ledge 11 and the at least one handle 4. To that end, the at least one handle 4 extends laterally from the rim 5, parallel to the base 7, such that with the help of the at least one handle 4, the present invention may sit on the lip of a variety of totes and bins.

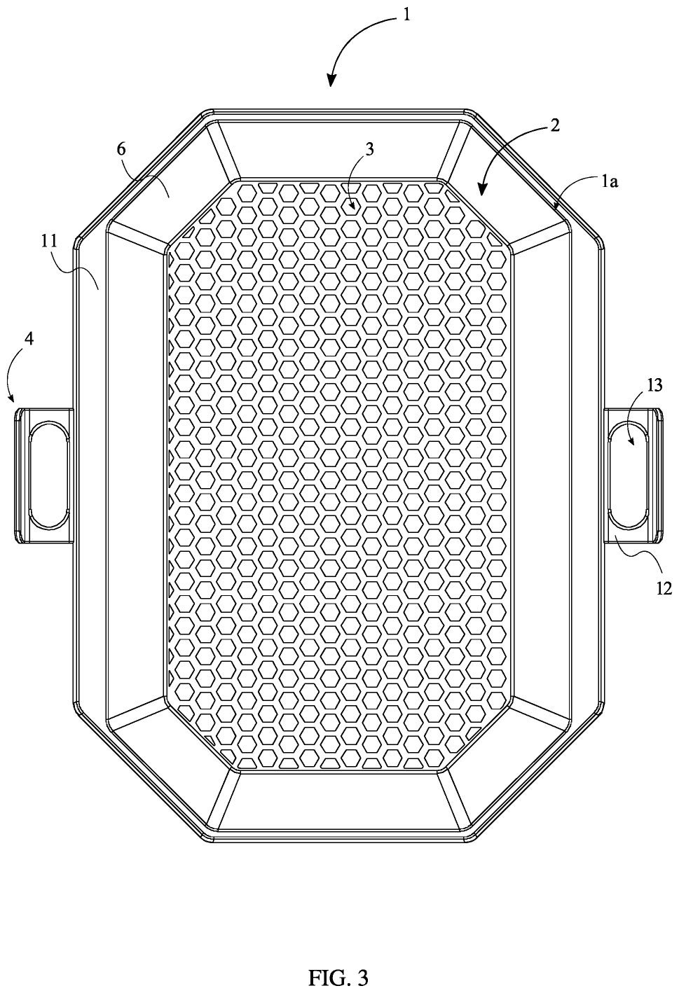

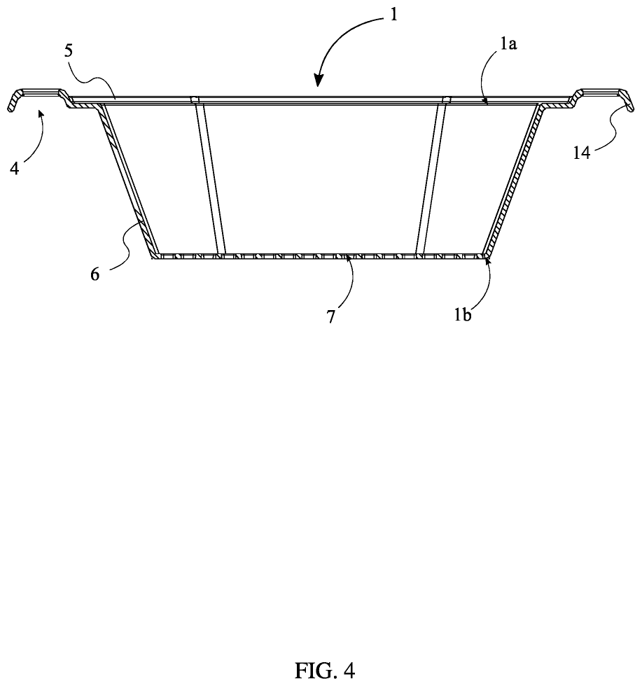

As seen in FIG. 3 and FIG. 4, the at least one handle 4 comprises a handle body 12, a handhold perforation 13, and a hooked edge 14 in the preferred embodiment of the present invention. Preferably, the handle body 12 defines a substantially rigid extension of the material of the receptacle 1 suitable to support the weight of the present invention and a load of marijuana buds/plant material, as the entire assembly is shaken to agitate the plant material. To accomplish this, and to provide a strong hold, the handle body 12 is terminally mounted onto the rim 5. Further, the handhold perforation 13 traverses into the handle body 12 such that the handhold perforation 13 offers a more comfortable and secure means of maintaining a grasp on the present invention during use. Furthermore, the hooked edge 14 is terminally connected to the handle body 12. As clearly seen in FIG. 4, the hooked edge 14 constitutes a material deflection of the handle body 12 opposite the rim 5 across the handhold perforation 13. This formation may suspend the receptacle 1 over a bin by mounting to the edge of said bin, carry a collection bag to directly capture any separated plant material, mount to the receptacle 1 of a successive iteration of the horticulture classifying apparatus, or any combination thereof depending on individual use cases. The application of the present invention to any external items is considered outside the scope of the present invention, and any necessity therein should not be implied.

Although the invention has been explained in relation to its preferred embodiment, it is to be understood that many other possible modifications and variations can be made without departing from the spirit and scope of the invention as hereinafter claimed.

What is claimed is:

1. A sifting apparatus for agricultural products, comprising:
a receptacle;
an inner cavity;
a plurality of first perforations;
at least one handle;
the receptacle comprising a rim, at least one lateral sidewall, and a base;
a first end of the receptacle being positioned opposite to a second end of the receptacle across the at least one lateral sidewall;
the inner cavity traversing into the receptacle from the first end towards the second end;
the rim being mounted adjacent the first end;
the base being mounted adjacent the second end;
the lateral sidewall tapering from the first end towards the second end;
the plurality of first perforations traversing into the base; and
the at least one handle being perimetrically mounted onto the rim.

2. The sifting apparatus of claim 1, wherein each of the plurality of first perforations comprising filleted edges.

3. The sifting apparatus of claim 1, comprising:
a sifter screen;
a plurality of second perforations;
the sifter screen being detachably mounted over the base; and
the plurality of second perforations traversing into sifter screen.

4. The sifting apparatus of claim 3, comprising:
a plurality of fasteners;
the plurality of fasteners being engaged between the sifter screen and the base.

5. The sifting apparatus of claim 3, wherein each of the plurality of second perforations being diamond in shape.

6. The sifting apparatus of claim 3, wherein each of the plurality of second perforations being smaller than each of the plurality of first perforations.

7. The sifting apparatus of claim 3, wherein a first transverse cross-section of the base being identical to a second transverse cross-section of the sifting screen.

8. The sifting apparatus of claim 3, wherein each of the plurality of second perforations comprising rounded edges.

9. The sifting apparatus of claim 1, comprising:
an annular ledge;
the annular ledge being perimetrically mounted onto the first end.

10. The sifting apparatus of claim 9, comprising:
the rim being perimetrically and terminally mounted onto the annular ledge.

11. The sifting apparatus of claim 9, wherein the annular ledge extending laterally away from the first end, parallel to the base.

12. The sifting apparatus of claim 9, wherein the rim extending normally from the annular edge, opposite to the base.

13. The sifting apparatus of claim 1, the at least one handle comprising:
a handle body;
a handhold perforation;
a hooked edge;
the handle body being terminally mounted onto the rim;
the handhold perforation traversing into the handle body; and
the hooked edge being terminally connected to the handle body.

14. The sifting apparatus of claim 1, wherein each of the plurality of first perforations being hexagonal in shape.

15. The sifting apparatus of claim 1, wherein the receptacle being octagonal in shape.

16. The sifting apparatus of claim 1, wherein the at least one handle extending laterally from the rim, parallel to the base.

17. A sifting apparatus for agricultural products, comprising:
a receptacle;
an inner cavity;
a plurality of first perforations;
at least one handle;
the receptacle comprising a rim, at least one lateral sidewall, and a base;
a first end of the receptacle being positioned opposite to a second end of the receptacle across the at least one lateral sidewall;
the inner cavity traversing into the receptacle from the first end towards the second end;
the rim being mounted adjacent the first end;
the base being mounted adjacent the second end;
the lateral sidewall tapering from the first end towards the second end;
the plurality of first perforations traversing into the base, wherein each of the plurality of first perforations comprising filleted edges; and
the at least one handle being perimetrically mounted onto the rim.

18. The sifting apparatus of claim 17, comprising:
a sifter screen;
a plurality of second perforations;
the sifter screen being detachably mounted over the base; and
the plurality of second perforations traversing into sifter screen.

19. The sifting apparatus of claim 18, comprising:
a plurality of fasteners;
the plurality of fasteners being engaged between the sifter screen and the base.

20. The sifting apparatus of claim 17, comprising:
an annular ledge;
the annular ledge being perimetrically mounted onto the first end; and
the rim being perimetrically and terminally mounted onto the annular ledge.
